(19) United States
(12) Patent Application Publication
(10) Pub. No.: US 2024/0029455 A1
(43) Pub. Date: Jan. 25, 2024

(54) SEMANTIC-GUIDED TRANSFORMER FOR OBJECT RECOGNITION AND RADIANCE FIELD-BASED NOVEL VIEW

(71) Applicant: Intel Corporation, Santa Clara, CA (US)

(72) Inventors: Peixi Xiong, Hillsboro, OR (US); Nilesh Jain, Portland, OR (US); Ravishankar Iyer, Portland, OR (US); Mrutunjayya Mrutunjayya, Santa Clara, CA (US)

(21) Appl. No.: 18/475,353

(22) Filed: Sep. 27, 2023

(51) Int. Cl. G06V 20/64; G06V 20/70; G06T 15/20; G06V 10/56; G06V 10/774

(52) U.S. Cl. CPC G06V 20/64; G06V 20/70; G06T 15/20; G06V 10/56; G06V 10/774

(57) ABSTRACT

Systems, apparatuses and methods may provide for technology that encodes multi-view visual data into latent features via an aggregator encoder, decodes the latent features into one or more novel target views different from views of the multi-view visual data via a rendering decoder, and decodes the latent features into an object label via a label decoder. The operation to decode the latent features via the rendering decoder and to decode the latent features via the label decoder occur at least partially at the same time. The operation to encode, via the aggregator encoder, the multi-view visual data into the latent features further includes operations to: perform, via the aggregator encoder, semantic object recognition operations based on radiance field view synthesis operations, and perform, via the aggregator encoder, radiance field view synthesis operations based on semantic object recognition operations.

### TECHNICAL FIELD

Embodiments generally relate to object recognition transformers. More particularly, embodiments relate to a semantic-guided transformer for object recognition and radiance field-based novel views.

### BACKGROUND

Three-dimensional (3D) object recognition and radiance-field-based (RF-based) novel view synthesis are two active research areas in the 3D feature representation domain. The 3D object recognition task involves classifying objects situated in 3D space, which may be accomplished by analyzing either a set of images or point cloud data. The multiview-based approach, in particular, entails recognizing 3D objects by integrating information gathered from numerous two-dimensional (2D) views acquired from diverse perspectives.

Separately, radiance-field-based novel view synthesis is an intricate technique that captures and reconstructs the visual appearance of objects or scenes by employing a process that involves capturing images from varying view points and subsequently approximating the radiance field—a mathematical representation that describes the visual appearance of an object as a function of viewing direction. More generally, the field of radiance field (RF) based novel view synthesis is utilized to generate novel views of complex 3D scenes based on a partial set of 2D images.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a semantic-guided transformer for object recognition and radiance-field-based novel view synthesis according to an embodiment;

FIG. 2 is another illustration of an example of a semantic-guided transformer for object recognition and radiance-field-based novel view synthesis according to an embodiment;

FIG. 3 is an illustration of an example of a visualization of feature embedding of objects according to an embodiment;

FIG. 4 is an illustration of an example chart showing experimental results in Table 1 according to an embodiment;

FIG. 5 is an illustration of an example chart showing experimental results in Table 2 according to an embodiment;

FIG. 6 is an illustration of an example chart showing experimental results in Table 3 according to an embodiment;

FIG. 7 is a flowchart of an example method of performing object recognition and radiance-field-based novel view synthesis according to an embodiment;

FIG. 8 is a signaling diagram of another example method of performing object recognition and radiance-field-based novel view synthesis according to an embodiment;

FIG. 9 is a signaling diagram of a further example method of performing object recognition and radiance-field-based novel view synthesis according to an embodiment;

FIG. 10 is a block diagram of an example of a performance-enhanced computing system according to an embodiment;

FIG. 11 is an illustration of an example of a semiconductor package apparatus according to an embodiment;

FIG. 12 is a block diagram of an example of a processor according to an embodiment; and

FIG. 13 is a block diagram of an example of a multi-processor based computing system according to an embodiment.

### DETAILED DESCRIPTION

As discussed above, different solutions have been proposed for addressing specific challenges of the field of three-dimensional (3D) object recognition as compared to the separate field of radiance field (RF) based novel view synthesis.

In the field of 3D object recognition, some approaches have proposed a generative model for unsupervised identification of 3D shape structures, incorporating additional human-provided information, or developing weakly supervised techniques. Annotating additional data by humans, however, is costly, and the improvements achieved by these methods are limited.

Concerning RF-based novel view synthesis, the focus is often on the generalization ability due to robustness concerns and the proposal of cross-scene rendering. Some approaches rely on scalable external data to improve generalization ability. These approaches, however, require massive training data, and there is considerable room for improvement with respect to the learning efficiency of these models.

As will be described in greater detail below, a semantic-guided transformer based on a deep learning model that uses self-attention to process sequential input data (e.g., via a neural network) is provided for both object recognition and radiance-field-based novel view synthesis. The semantic-guided transformer for object recognition and radiance-field-based novel view synthesis is also referred to herein as “2R-TRM,” where 2R encompasses 3D object [R]ecognition and [R]adiance-field-based novel view synthesis). The semantic-guided transformer for object recognition and radiance-field-based novel view synthesis (2R-TRM) unifies these two tasks by integrating object semantic information into visual features from multiple viewpoints. This integration enhances the learning of latent features and underlying patterns. Additionally, a semantic understanding module is utilized to guide feature learning through the incorporation of noise contrastive estimation, in some examples.

The technology described herein integrates two formerly separate research tasks: 3D object recognition and radiance-field-based novel view synthesis, which aims to classify and represent 3D objects based on visual information from multiple viewpoints, respectively. The existence of this problem is driven by two factors. First, the techniques described herein can generate a 360-degree view video and provide semantic labels for commercial purposes. Secondly, both tasks involve understanding and recognizing 3D object materials, shapes, and structures from multiple viewpoints. The challenges in these tasks include accounting for scene/environment properties, such as lighting conditions, and addressing deficiencies such as cross-scene/object generalization and learning efficiency in radiance field representation. The specific problem of interest is how to effectively integrate these two tasks and leverage their mutual benefits, where radiance-field-based (RF-based) novel view synthesis enhances 3D object recognition by capturing crucial object details, while 3D object recognition provides semantic knowledge to aid radiance-field-based view synthesis learning.

The integration of these two tasks leads to mutual benefit. On the one hand, RF-based novel view synthesis yields superior 3D object representations, capturing crucial details pertaining to texture, shape, and structure of objects, thereby facilitating the model's ability to differentiate among various object categories. On the other hand, 3D object recognition endows RF-based novel view synthesis with semantic knowledge. As the semantic label embodies an abstract understanding and generalization of the object, combining the recognition task provides guidance to RF-based novel view synthesis learning, consequently enhancing model efficiency. In addition, the combination of two tasks realizes an application that can simultaneously generate 360-degree rendered video and recognize 3D objects. Further, involving object label prediction makes it possible to retrieve stock keeping unit (SKU) information.

Advantageously, by integrating the tasks of 3D object recognition and RF-based novel view synthesis, the semantic-guided transformer for object recognition and radiance-field-based novel view synthesis (2R-TRM) provides mutual benefits to both domains. The transformer (e.g., also referred to herein as a model) enhances the learning of latent features and underlying patterns, resulting in improved performance in 3D object recognition and RF-based novel view synthesis. The inclusion of semantic information further enhances the efficiency of the model.

Moreover, the combination of these tasks allows for the simultaneous generation of 360-degree rendered videos and 3D object recognition. This integration brings benefits by enabling the retrieval of stock keeping unit (SKU) information. This capability becomes particularly relevant in the context of augmented reality (AR) and virtual reality (VR) devices, where accurate and real-time object recognition coupled with immersive experiences is in high demand. The technology described herein, therefor effectively bridges the gap between rendering video applications and object label prediction, providing practical applications.

As will be described in greater detail below, a specific structural feature of the techniques described herein are the latent features extracted from the aggregation encoder. As used herein, the term “latent features” refers to features learned through the joint task of integrating 3D semantic object recognition and RF-based novel view synthesis, where the latent features are learned through the joint task of integrating 3D semantic object recognition and radiance field view synthesis to incorporate semantic information from 3D semantic object recognition to aid radiance field view synthesis rendering and incorporate radiance field information from radiance field view synthesis rendering of a 3D scene to enhance the 3D semantic object recognition. In the machine learning domain, latent features are defined as the underlying, non-explicit characteristics or patterns in the data that a model (e.g., in this case, the aggregation encoder) discovers or leverages during its learning process. These patterns can manifest as similar visual structures across different views and different instances within the same category. The latent features capture the underlying patterns and relationships between the two modalities by incorporating semantic information from recognition to aid rendering (e.g., radiance field view synthesis operations) and incorporating radiance field features from the 3D scene to enhance the recognition task (e.g., semantic object recognition operations). These latent features enable improved performance and providing valuable insights into the interplay between object recognition and novel view synthesis.

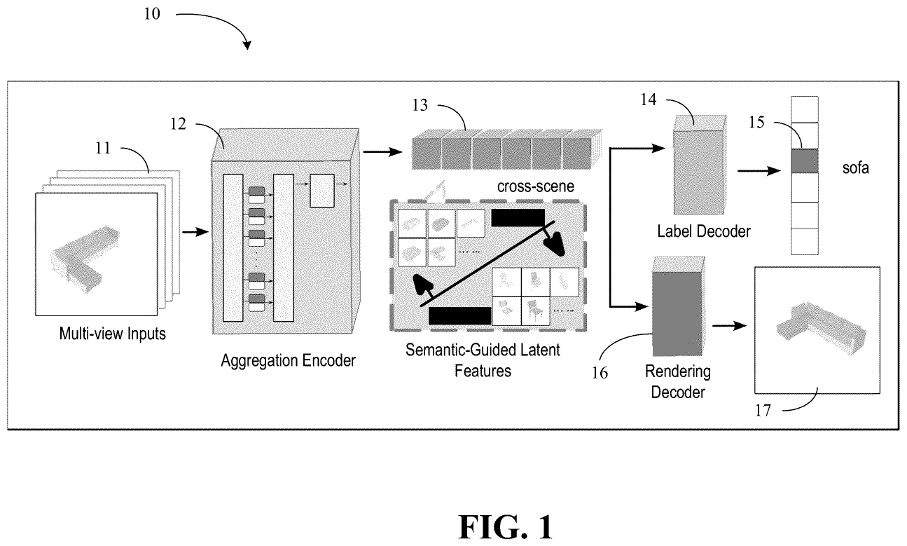

FIG. 1 is an illustration of an example of a semantic-guided transformer 10 for object recognition and radiance-field-based novel view synthesis (2R-TRM) according to an embodiment. As illustrated, unlike studies that handled 3D object recognition and novel view synthesis as independent tasks (resulting in information and knowledge being segregated into two different domains), the semantic-guided transformer 10 unifies these tasks. For example, the semantic-guided transformer 10 unifies these tasks by utilizing semantic information from recognition to aid rendering and incorporating radiance field features from the 3D scene to improve the recognition task. The joint task leads to better learning of latent features and the underlying patterns for both tasks.

In some examples, the semantic-guided transformer 10 unifies the 3D object recognition and radiance-field-based view-synthesis/representation training, incorporating object semantic information into visual features from multiple viewpoints. For example, multi-view visual data 11 (e.g., RGB (red, green, blue) multi-view images) are encoded and fused by an aggregation encoder 12 to produce latent features 13, while a label decoder 14 and a rendering decoder 16 are utilized to infer object labels 15 and synthesize novel target views 17 based on target view directions, respectively.

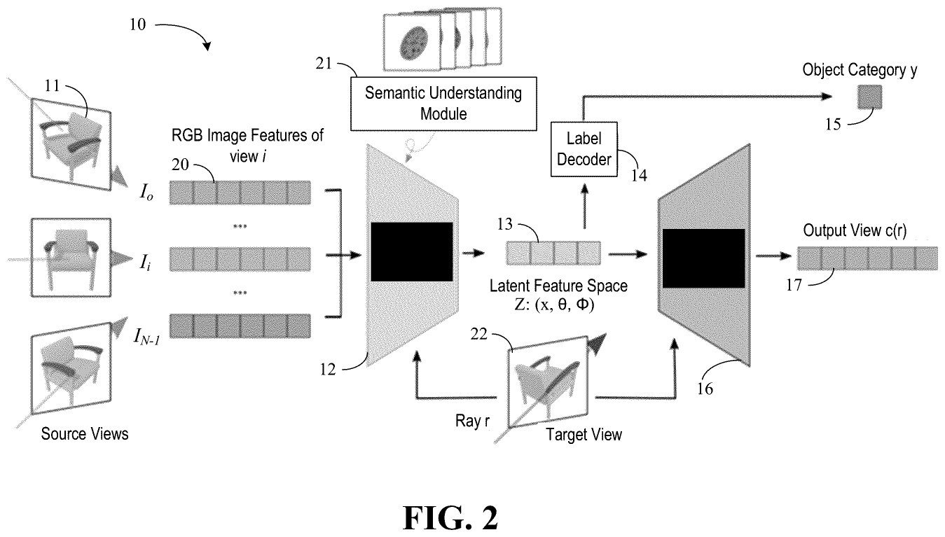

FIG. 2 is another illustration of an example of the semantic-guided transformer for object recognition and radiance-field-based novel view synthesis (2R-TRM) according to an embodiment. As illustrated, the semantic-guided transformer 10 focuses on incorporating object semantic information into visual features from different views.

For example, the semantic-guided transformer 10 includes two stages: encoding visual view features into latent features via aggregation encoder 12 and decoding them via label decoder 14 to obtain object labels 15 and via and rendering decoder 16 to obtain novel target views 17. The aggregation encoder 12 processes multi-view visual data 11 of numerous two-dimensional (2D) views acquired from diverse perspectives to create latent features 13 (e.g., including a coordinate-aligned feature field). For example, the multi-view visual data is associated with visual view features. As used herein, the term “visual view features” refers to RGB (or the like) image features of view i 20 and corresponding camera projection matrices from multiple two dimensional views. The visual view features in view I (e.g., shown as Iᵢ in FIG. 2) are the RGB features for that view. These features have a size based on the width (w) and height (h) of the image, and they have 3 color channels: red, green, and blue. The value I(m,n,c)ᵢ shows the intensity of a pixel at the position (m,n) in a specific color channel (c) in view i. The rendering decoder 16 utilizes the latent features 13 to render novel target views 17 (e.g., as the color of camera rays). Simultaneously, the label decoder 14 decodes the latent features 13 to obtain object labels 15.

In some examples, the aggregation encoder 12 is responsible for aggregating the multi-view visual data 11 (e.g., source views) into latent features 13. For example, the aggregation encoder 12 aggregates different source views into a coordinate-aligned feature field.

In some implementations, next, the rendering decoder 16 composes coordinate-aligned features from the latent features 13 along a target ray of a target view 22 to obtain the novel target views (e.g., including obtaining the color). For example, point-wise colors are mapped to token features and achieve weighted aggregation to get the final output by the rendering decoder 16.

In some examples, simultaneously, the label decoder 14 further integrates latent features 13 and maps them into object labels 15 (e.g., object categories). For example, the label decoder 14 non-linearly maps the latent features 13 into the object labels 15 (e.g., object categories).

In some implementations, to enhance the attending of semantic features to latent features, a self-supervised semantic understanding module 21 is included in the training process. The semantic understanding module 21 promotes improved feature representation. During the training phase, the semantic understanding module 21 is responsible for encouraging better semantic leading. For example, the semantic understanding module 21 further encourages semantic guidance in training by leading the learning of features by incorporating noise contrastive estimation.

Overview

Details of the proposed the semantic-guided transformer 10 for object recognition and radiance-field-based novel view synthesis (2R-TRM) are described in greater detail below. The main idea of the semantic-guided transformer 10 model is to attend object semantic information into visual features of different views. FIG. 2 depicts the architecture of the proposed model, which includes of two stages: encoding visual view features into latent features, and decoding them into object labels y and novel target views c. First, the RGB images

[symbol]

and their corresponding camera projection matrix

[symbol]

indicating the poses from N different views are fed into the aggregation encoder (A), to aggregate different views into a coordinate-aligned feature field, Z. Then, the latent features z is fed into the rendering decoder (Dᵣ), to obtain the rendered color c of camera ray r. Meanwhile, z is decoded by the label decoder (Dₗ). To make semantic features better attend latent features, the semantic understanding module (U) is designed to self-supervise the training process for a better feature representation.

Aggregation Encoder

As will be described in greater detail below, in some implementations, the aggregation encoder aggregates different source views into a coordinate-aligned feature field. More specifically, Given N source view images

{ [symbol] ∈ [symbol] ^{H×W×3}

[symbol]

and their corresponding camera projection matrix

{Pᵢ∈R^{3×4}}^{N-1},

{ [symbol] ∈ [symbol] ^{3×4}}ᵢ₌₀^{N-1}

the goal of the aggregation encoder is to aggregate visual features extracted from source views according to the camera and geometry priors and output latent features that are used for later modules.

First, each source view (Iᵢ) is encoded into feature map

f: [symbol] ∈ [symbol] ^{H×W×3} [symbol] [symbol] ∈ [symbol] ^{H×W×d}^{_{view}}

using a U-Net based convolutional neural network, where d_{view} is its corresponding dimension and i is the source view index. Compared with encoding an entire scene, one model disclosed herein interpolates the feature vector on the image plane. In addition, with the similar concern that involving every pixel of source view features is of high memory cost, one model disclosed herein introduces the epipolar geometry as indicative bias, restricting each pixel only attending to pixels that lie on the corresponding epipolar lines of neighboring views. Specifically, to obtain the feature at spatial coordinate x∈R³ and 2D viewing directions (θ,ϕ)∈[−π,π]² (in practice, the directions are expressed as a 3D Cartesian unit vector d), the coordinates x are projected into feature space, and bilinear interpolation is performed with nearby neighboring view features on the corresponding epipolar lines. These features are regarded as coordinate-aligned token features ({eᵢ}^{N-1}) for the Transformer in Aggregation Encoder:

[symbol]

ᵢ(x,d)= [symbol] ( [symbol] (x),d)∈ [symbol] ^{d}^{_{view}}, (1)

where \tilde{ }x=Rᵢ(x)∈R² is the projection from x to i^{th} image plane by applying the extrinsic matrix, and Xᵢ(\tilde{ }x, d) computes the feature vector at coordinate \tilde{ }x via interpolation.

The positional embedding of the Transformer is obtained by a learnable positional encoder (PE_{A}) over relative directions (Δd) of the source view to the target view:

p=P [symbol] (Δd)∈ [symbol] ^{d}^{_{view}}. (2)

The reason for involving relative directions instead of absolute directions is that it is preferred to obtain closer token indexes over similar views between the source and target, since a smaller difference between the target view and the source views typically implies a larger probability of the target view resembling the corresponding colors at the source views and vice versa.

Then, the tokens are concatenated with the positional information and fed into the Transformer architecture (TRM_{A}), achieving view aggregation and outputting coordinate-aligned latent features Z:

Z(x,d)=TRM [symbol] ([ [symbol] (x,d); [symbol] (3)

In summary, Z(x, d) represents the 3D latent feature for a single query point location x on a ray r with the unit-length viewing direction d (e.g., the 5D location: 3D spatial coordinate x, and 2D viewing direction θ, ϕ), and involves the view difference between the target view and the source view. These will be used for the rendering decoder by querying target view 5D locations, and the label decoder by further integrating the latent features.

Rendering Decoder

As will be described in greater detail below, in some implementations, the point-wise colors are mapped to token features in the Transformer and achieve weighted aggregation to get the final output by rendering the decoder. More specifically, Generalizable 3D representations may be learnable from seen views to achieve novel view synthetization. The synthesis process can be regarded as a weighted aggregation of view features, and this process depends on the target view direction and its difference from the source view directions. In such a circumstance, the Transformer architecture attention mechanism is one of the solutions to achieve learning the correlations.

From Eq. 3 the target view 5D locations (xₖ, d) are injected to obtain the queried tokens, Z(xₖ, d), where xₖ=o+tₖd, partitioning the near and far bounds ([tₙ, t_{f}]) into M evenly spaced bins and randomly and uniformly sampling within each bin:

$${t}_{k} \sim [ {t}_{n} + \frac{k - 1}{M} ( {t}_{f} - {t}_{n} ) , {t}_{n} + \frac{k}{M} ( {t}_{f} - {t}_{n} ) ] \qquad ( 4 )$$

To aggregate the features from all sampled points, the Transformer (TRM_{D}r) and its corresponding positional encoder (PE_{D}r) are applied to the queried features due to its better self-attention property. The reason for using target directions instead of relative directions is to separate tokens from different view directions with different positional indexing. The accumulated colors along the ray (r=(o, d)) are then obtained by weighted pooling over the output self-attention-attended tokens, and then mapping the result to RGB space via a few-layer MLP:

c(r)=MLP_{rgb}(meanₖ₌₀^{M-1}Wₖ·hₖ), (5)

hₖ= [symbol] ([Z(xₖ,d);p]), (6)

p=P [symbol] (d), (7)

Where

{Wₖ}ₖ₌₀^{M-1}

are the pooling weights.

The Rendering Decoder is supervised by minimizing the mean squared error between the rendered colors and ground truth pixel colors in the training phase:

$${ℒ}_{r} = {\sum }_{r ∈ B} {‖ \tilde{c} ( r ) - c ( r ) ‖}_{2}^{2} , \qquad ( 8 )$$

where B is the set of rays in each training batch.

Label Decoder

As will be described in greater detail below, in some implementations, the label decoder non-linearly maps the latent features into the object categories. More specifically, to represent the object category features, features along each source ray are first integrated by weighted pooling Wⱼ latent features Z at all points in each ray direction. Then, an MLP is applied to the features to project the aggregated ray features into another feature space with dimension d_{obj}. Formally, Eq. 9 illustrates how to obtain ray-related token features (fᵣ) from 5D location-dependent features, Z(x, d).

$${f}_{r} = {MLP}_{obj} ( {mean}_{( {x}_{j} , d ) ∈ pts in r} {W}_{} \cdot Z ( {x}_{j} , d ) ) \qquad ( 9 )$$

Similar to Eq. 6 and 7, a transformer (TRM_{Dc}) and its positional encoder (PE_{Dc}) are used to integrate ray-related token inputs of all source rays. Different from previous Transformers, in order to perform classification, an extra learnable “classification token” is added to the sequence to perform classification.

z=TR [symbol] ([fᵣ;p]), (10)

p=P [symbol] (r), (11)

Finally, the classification results are generated from the output of TRM_{Dc}:

[symbol]

=FC(MLP_{cls}(LN(z))), (12)

where FC(⋅) is the fully connected layer, LN (⋅) represents the layer normalization and MLP_{cls}(⋅) denotes the MLP layers.

The Label Decoder is supervised by minimizing the cross-entropy loss.

[symbol]

ₗ= [symbol] _{ce}( [symbol] , [symbol] _{gt}), (13)

where y_{gt} represents the ground-truth label.

Semantic Understanding Module

As will be described in greater detail below, in some implementations, the semantic understanding module is introduced to further facilitate the semantic information that assists the 2R dual task. The objective of this module is to encourage the latent features from the aggregation encoder to obtain a proper distance with the object semantic features in the pre-training phase. Equation 14 below aims to learn a better distance between latent features and semantic features. More specifically, a distance is adjusted between the latent features and object semantic features via the semantic understanding module. Specifically, Equation 14 encourages the learning of latent features such that there's a pronounced difference between the distances of the latent features to positive semantic features and to negative semantic features.

As described above, the latent features are learned from the multi-view visual data using an aggregation encoder. They capture the latent patterns of a category, such as its structural properties. The latent features are those learned from the current multi-view visual input of an object in category A.

As used herein, the term “semantic features” refers to the Global Vectors for Word Representation (GloVe) features associated with the category label, which can be a phrase or a word. GloVe is a method for obtaining vector representations (also known as embeddings) for words in natural language processing (NLP). These vector representations can capture semantic relationships between words based on their co-occurrence patterns in large corpora. To obtain GloVe word embeddings, one can either train their own embeddings on a specific corpus or use pre-trained embeddings.

The idea behind introducing positive and negative concepts with respect to the semantic features is to guide the learning of latent features. The goal is to ensure that the latent features maintain a suitable distance to the positive semantic features compared to the distance they have to the negative semantic features.

More specifically, Equation 14 uses two types of semantic features. The positive semantic features are the GloVe features corresponding to semantic label A. Conversely, the negative semantic features are the GloVe features for semantic label B. Category B is randomly selected from the dataset, provided it's distinct from category A. For example, each category (e.g., category A and category B) comprises multiple objects. The relationship between the semantic label, category, and semantic features can be illustrated as follows: category—class index 0, semantic label—the word “chair”, semantic features—a vector representing the GloVe features of the word “chair”.

A noise contrastive estimation (NCE) is employed over features to bring the latent features for each source view ray r closer to the object semantic features (s+) than the other features (s−) randomly sampled from the list. For a shorter notation, Z(r) is used to represent the mean pooling of hidden features along the ray r. The semantic features of the object are the GloVe embedding of the object name.

In this work, the softmax version of the NCE loss is used:

$${ℒ}_{NCE} = - {\sum }_{r ∈ O} log ( \frac{{e}^{{Z ( r )}^{⊤} g ( {s}^{+} )}}{{e}^{{Z ( r )}^{⊤} g ( {s}^{+} )} + {\sum }_{( r , i ) ∈} {e}^{{Z ( r )}^{⊤} g ( {s}_{-}^{} )}} ) , \qquad ( 14 )$$

where O represents all rays for the object view, N is the set of negative pairs, meaning that the semantic features do not match current latent features, and do not describe the current 3D object. g(⋅) maps GloVe features into the same d_{view}-dimensional vector space as Z.

Implementation Details

In an experimental implementation described in greater detail below, the extraction of multi-view image features is accomplished through an architecture that resembles a U-Net. The aggregation encoder configuration was based on GNT. The scale of the Transformer may be reduced, with three layers and four attention heads. Both the rendering and label decoders possess a Transformer structure consisting of four layers and four attention heads. In some implementations, the dimension of the latent feature vector, Z, is 64, while all other hidden layer dimensions are 32. The semantic understanding module is established for the pre-training phase. For example, 30% of training data will be used as pre-training data, and neither of them is seen in the evaluation. In some examples, the related parameters are not frozen during the training phase; instead, they only function as semantic guidance for the model. For the experiments below, the negative sample number was set to 5. Distributed data-parallel training was performed on four NVIDIA A100 GPUs, with the learning rate set to e-4 with the Adam optimizer.

Experiment Results:

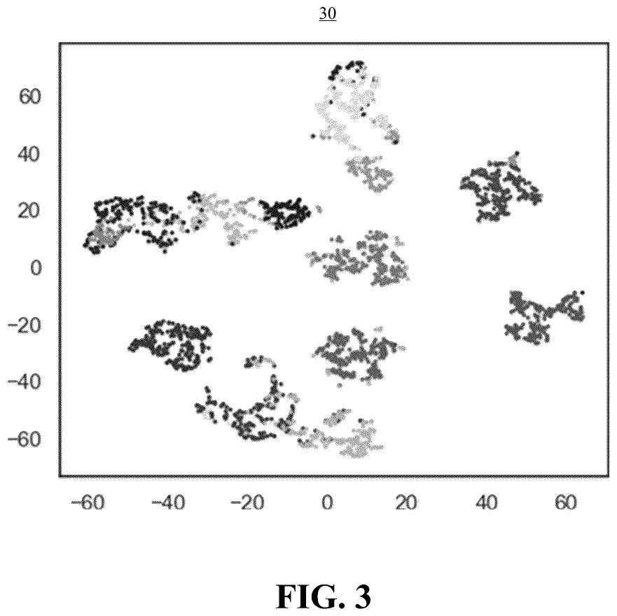

FIG. 3 is an illustration of an example of a visualization 30 of feature embedding of objects according to an embodiment. As illustrated, FIG. 3 displays a visualization 30, where each data point represents the feature of an individual object extracted from the layer preceding the fully connected (FC) layer in the label decoder block. To assess the effectiveness of the semantic-guided feature representation, the experiment utilized T-distributed Stochastic Neighbor Embedding (t-SNE) for visualizing the latent features of randomly selected 15 object categories. Notably, objects belonging to the same category are positioned closer to one another in the feature space, while those from different categories are more distantly separated. This observation highlights the model's ability to extract and distinguish semantic-guided features, demonstrating the efficacy of the proposed approach.

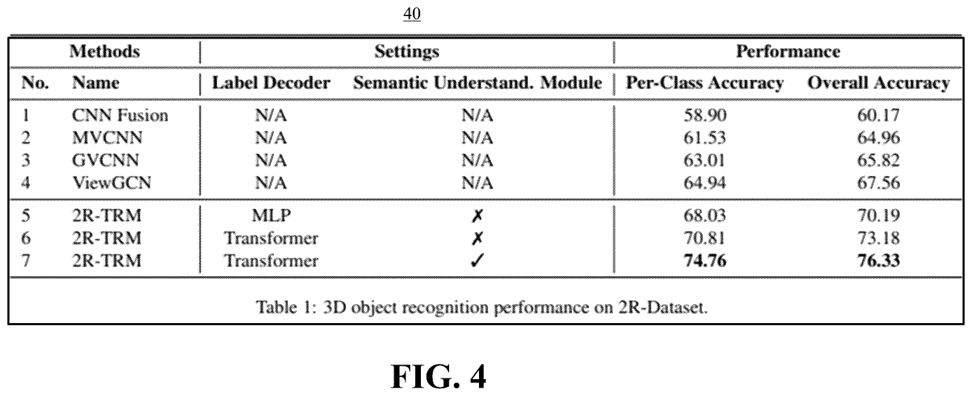

FIG. 4 illustrates a chart 40 showing Table 1 that is directed to 3D object recognition performance on a 2R-Dataset, comparing a model disclosed herein with several existing methods. MVCNN is a CNN-based architecture that combines information from multiple views to create a compact shape descriptor. GVCNN proposed a group-view CNN framework for hierarchical correlation modeling in 3D shape description. ViewGCN utilizes a view-based Graph Convolutional Neural Network to represent 3D shapes based on graph representations of multiple views. A Multi-view CNN is also designated, labeled as “CNN Fusion” in the table. This model extracts visual features using a CNN and utilizes early fusion mechanisms on those features for prediction.

The results, as shown in Table 1, demonstrate that the 2R-TRM model disclosed herein outperforms the other methods in terms of accuracy in both sets. This indicates the superiority of the model disclosed herein in 3D object recognition under limited training data.

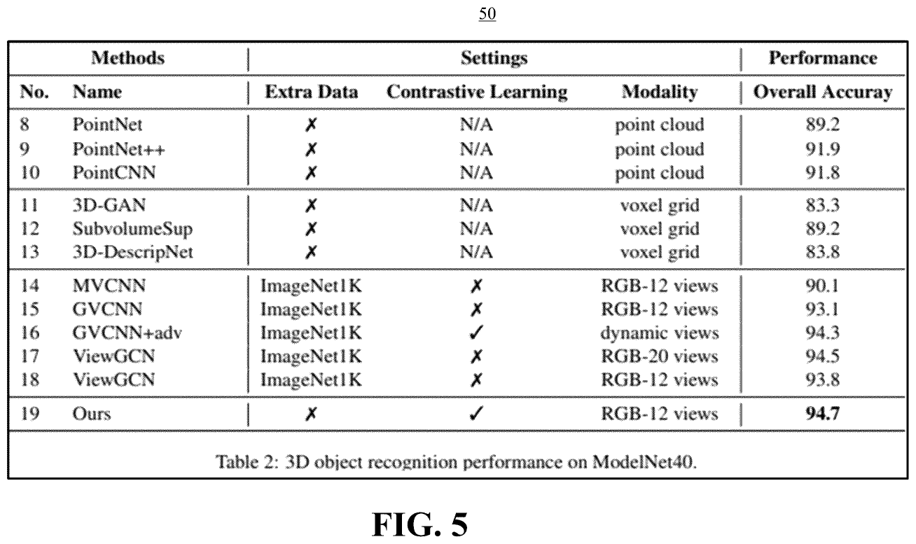

FIG. 5 illustrates a chart 50 showing Table 2 that is directed to 3D object recognition performance on a ModelNet40 dataset, comparing a model disclosed herein with several existing methods. Table 2 includes information on the input data type, modality, and different settings for the number of views in the case of RGB-image inputs. The “Extra Data” column indicates techniques that require additional datasets for pre-training CNN architectures.

The model disclosed herein is compared against other approaches on the ModelNet40 dataset. The results highlight that the model disclosed herein outperforms the other methods that use additional data for pre-training or input a higher number of views. This demonstrates the superior learning efficiency of the model disclosed herein, particularly when dealing with limited data.

Additionally, experiments 16 and 19 provide evidence that contrastive learning on visual inputs plays a role in 3D object recognition, further emphasizing the effectiveness of the model disclosed herein.

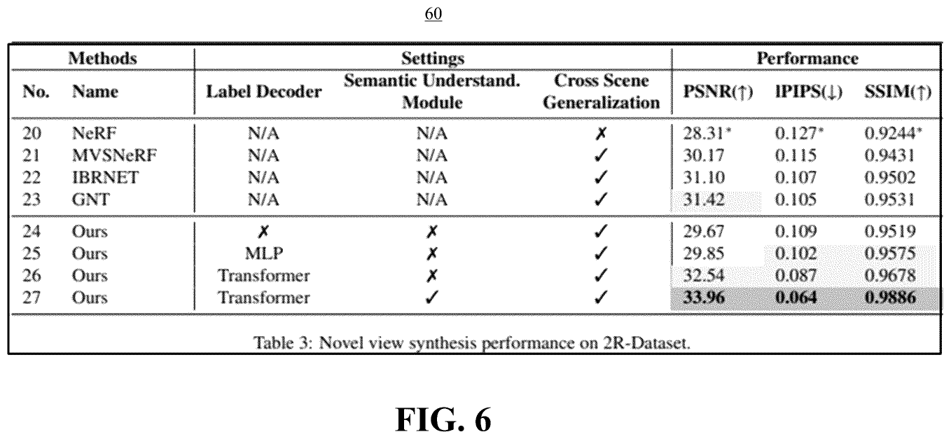

FIG. 6 illustrates a chart 60 showing Table 3 that is directed to novel view synthesis performed on a 2R-dataset, comparing a model disclosed herein with several existing methods. Ablation studies were conducted on the 2R-TRM model disclosed herein using the 2R-Dataset to evaluate the performance of each component. The results of these experiments are summarized in Table 1 and 3.

The columns labeled “Label Decoder” and “Semantic Understanding Module” indicate which model was used in the 3D object recognition stream and whether the semantic understanding mechanism was employed during training, respectively. Experiments 4 and 6 demonstrate that the Transformer architecture outperforms other models in aggregating features from multiple views to predict the label. Additionally, experiments 6 and 7 illustrate the effectiveness of the contrastive learning mechanism in the semantic understanding module. Experiments 24 to 27 show that the benefits of semantic understanding extend beyond 3D object recognition, as such an approach also improves the performance of novel view rendering by facilitating the learning of generalization features.

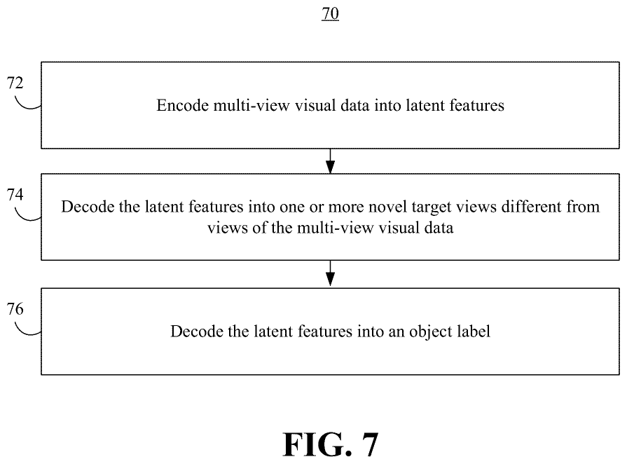

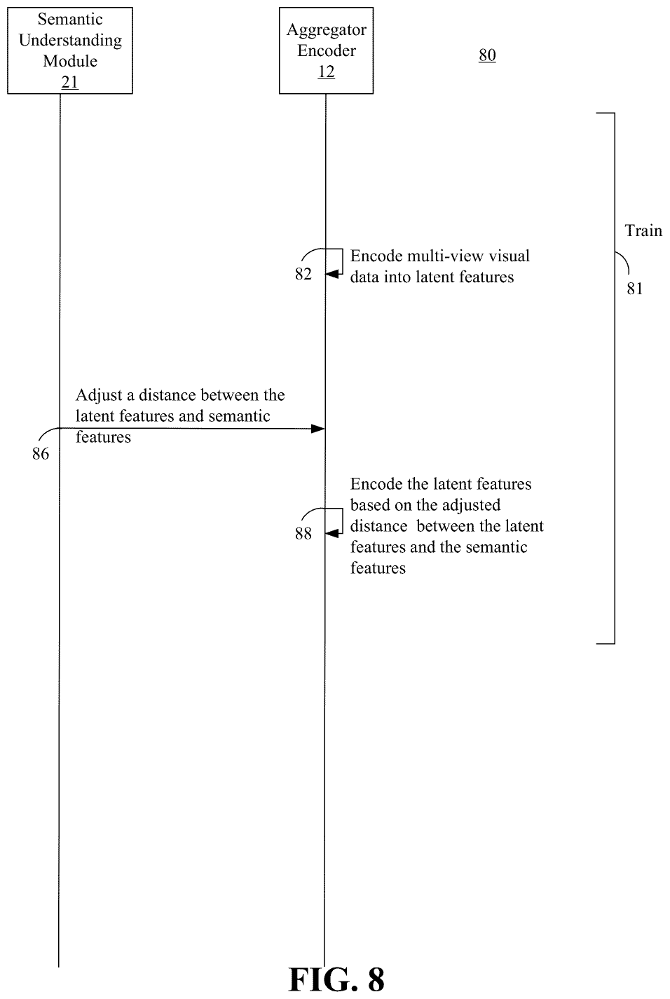

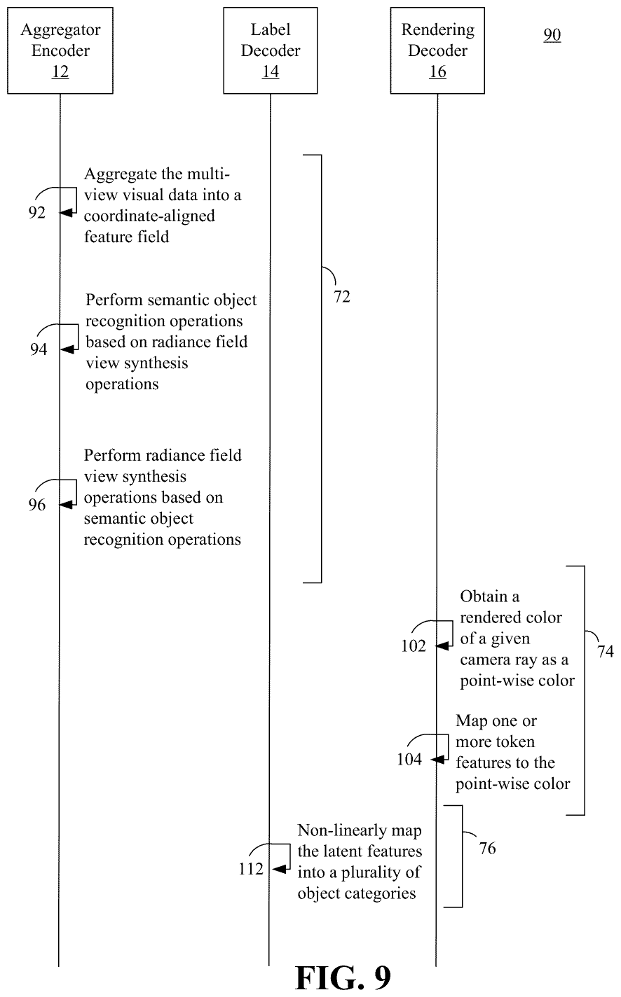

FIG. 7 shows a method 70 of performing object recognition and radiance-field-based novel view synthesis. The method 70 may generally be implemented in the semantic-guided transformer 10 for object recognition and radiance-field-based novel view synthesis (2R-TRM) (FIG. 1 and/or FIG. 2), already discussed. More particularly, the method 70 (as well as method 80 (FIG. 8) and/or method 90 (FIG. 9)) may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 70 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

In some examples, the methods described herein may be performed at least in part by cloud processing. It will be appreciated that some or all of the operations described herein that have been described using a “pull” architecture (e.g., polling for new information followed by a corresponding response) may instead be implemented using a “push” architecture (e.g., sending such information when there is new information to report), and vice versa.

Illustrated processing block 72 provides for encoding multi-view visual data. For example, visual view features of multi-view visual data are encoded into latent features via an aggregator encoder.

For example, latent features are learned through the joint task of integrating 3D object recognition and radiance field view synthesis to incorporate semantic information from 3D object recognition to aid radiance field view synthesis rendering and incorporate radiance field information from radiance field view synthesis rendering of a 3D scene to enhance the 3D object recognition.

As discussed above, a specific structural feature of the techniques described herein are the latent features extracted from the aggregation encoder. These latent features are learned through the joint task of integrating 3D object recognition and RF-based novel view synthesis. These latent features capture the underlying patterns and relationships between the two modalities by incorporating semantic information from recognition to aid rendering and incorporating radiance field features from the 3D scene to enhance the recognition task. These latent features enable improved performance and providing valuable insights into the interplay between object recognition and novel view synthesis.

In some examples, the aggregation encoder 12 is responsible for aggregating the multi-view visual data 11 (e.g., source views) into latent features 13. For example, the aggregation encoder 12 aggregates different source views into a coordinate-aligned feature field.

Illustrated processing block 74 provides for decoding the latent features into one or more novel target views. For example, the latent features are decoded into one or more novel target views different from views of the multi-view visual data via a rendering decoder.

In some implementations, the rendering decoder composes coordinate-aligned features from the latent features along a target ray of a target view to obtain the novel target views (e.g., including obtaining the color). For example, point-wise colors are mapped to token features and achieve weighted aggregation to get the final output by the rendering decoder.

Illustrated processing block 76 provides for decoding the latent features into an object label. For example, the latent features are decoded into an object label via a label decoder.

In some implementations, the operation to decode the latent features via the rendering decoder and to decode the latent features via the label decoder occur at least partially at the same time.

For example, the label decoder and rendering decoder operate on a unified data source of latent features. Accordingly, the label decoder and rendering decoder are able to operate in parallel, and potentially operate in parallel simultaneously. For example, the combination of two tasks realizes an application that can simultaneously generate 360-degree rendered video and recognize 3D objects.

In some examples, the label decoder and rendering decoder operate simultaneously on the same latent features. For example, the label decoder further integrates latent features and maps them into object categories. In some implementations, the label decoder non-linearly maps the latent features into the object categories.

In operation, the method 70 therefore enhances performance at least to the extent that by integrating the tasks of 3D object recognition and RF-based novel view synthesis, the semantic-guided transformer for object recognition and radiance-field-based novel view synthesis (2R-TRM) provides mutual benefits to both domains. The integration of these two tasks leads to mutual benefit. On the one hand, RF-based novel view synthesis yields superior 3D object representations, capturing crucial details pertaining to texture, shape, and structure of objects, thereby facilitating the model's ability to differentiate among various object categories. On the other hand, 3D object recognition endows RF-based novel view synthesis with semantic knowledge. As the semantic label embodies an abstract understanding and generalization of the object, combining the recognition task provides guidance to RF-based novel view synthesis learning, consequently enhancing model efficiency.

Additional and/or alternative operations for method 70 are described in greater detail below in the description of FIG. 8 and/or FIG. 9.

FIG. 8 shows a method 80 of performing object recognition and radiance-field-based novel view synthesis during training. The method 80 may generally be implemented in the semantic-guided transformer 10 for object recognition and radiance-field-based novel view synthesis (2R-TRM) (FIG. 1 and/or FIG. 2), already discussed.

As illustrated, operations 82-88 are discussed as occurring during training of the semantic-guided transformer.

Illustrated processing block 82 provides for encoding the multi-view visual data into latent features. For example, the visual view features are encoded from the multi-view visual data into latent features via the aggregator encoder.

Illustrated processing block 86 provides for adjusting a distance between the latent features and semantic features. For example, a distance is adjusted between the latent features and the semantic features via a semantic understanding module.

Illustrated processing block 88 provides for encoding the multi-view visual data into latent features. For example, visual view features are encoded from the multi-view visual data into latent features based on the adjusted distance between the latent features and the semantic features via the aggregator encoder.

In operation, in some implementations, to enhance the attending of semantic features to latent features, a self-supervised semantic understanding module 21 is included in the training process. The semantic understanding module 21 promotes improved feature representation. During the training phase, the semantic understanding module 21 is responsible for encouraging better semantic leading. For example, the semantic understanding module 21 further encourages semantic guidance in training by leading the learning of features by incorporating noise contrastive estimation.

FIG. 9 shows another method 90 of performing object recognition and radiance-field-based novel view synthesis. The method 90 may generally be implemented in the semantic-guided transformer 10 for object recognition and radiance-field-based novel view synthesis (2R-TRM) (FIG. 1 and/or FIG. 2), already discussed.

As illustrated, operations 92-96 may generally be incorporated into block 72 (FIG. 7), already discussed (e.g., the operation to encode, via the aggregator encoder, visual view features from the multi-view visual data into the latent features).

Illustrated processing block 92 provides for aggregating the multi-view visual data into a coordinate-aligned feature field. For example, the multi-view visual data is aggregated into a coordinate-aligned feature field via the aggregator encoder.

As used herein the term “coordinate-aligned feature field” refers to a 3D representation where every point or coordinate in that space is mapped to a unique feature descriptor or vector. This representation is constructed by converting multi-view images into a consistent and spatially aligned 3D grid of features. For example, the coordinate-aligned feature field provides a way to fuse information from multiple perspectives into a unified 3D feature space that corresponds to specific spatial coordinates.

In some examples, the multi-view visual data includes a plurality of red-green-blue images and a plurality of corresponding camera projection matrices. In some implementations, the multi-view visual data includes views of a plurality of different objects received together by the aggregator encoder.

Illustrated processing block 94 provides for performing semantic object recognition operations. For example, semantic object recognition operations are performed based on radiance field view synthesis operations via the aggregator encoder.

As used herein the term, “semantic object recognition operations” includes providing a semantic label (e.g., an object category) based on object recognition of physical objects. Such a semantic label embodies an abstract understanding and generalization of an object into an object category that semantically describes the object. In some examples, the label decoder integrates latent features and maps them into object labels (e.g., object categories). For example, the label decoder non-linearly maps the latent features into the object labels (e.g., object categories).

Separately, the term “radiance field view synthesis operations” refers to an intricate technique that captures and reconstructs the visual appearance of objects or scenes by employing a process that involves capturing images from varying view points and subsequently approximating the radiance field (e.g., a mathematical representation that describes the visual appearance of an object as a function of viewing direction). More generally, the radiance field view synthesis is utilized to generate novel views of complex 3D scenes based on a partial set of 2D images.

These two tasks are unified by integrating object semantic information into visual features from multiple viewpoints. This integration enhances the learning of latent features and underlying patterns. The technology described herein integrates two formerly separate research tasks: semantic object recognition operations (e.g., 3D object recognition) and radiance field view synthesis operations (e.g., radiance-field-based novel view synthesis), which aims to classify and represent 3D objects based on visual information from multiple viewpoints, respectively. Both tasks involve understanding and recognizing 3D object materials, shapes, and structures from multiple viewpoints. The challenges in these tasks include accounting for scene/environment properties, such as lighting conditions, and addressing deficiencies such as cross-scene/object generalization and learning efficiency in radiance field representation. These two tasks are integrated to leverage their mutual benefits, where radiance field view synthesis operations enhance semantic object recognition operations by capturing crucial object details, while semantic object recognition operations provides semantic knowledge to aid radiance field view synthesis learning.

For example, the radiance field view synthesis operations yield superior semantic object recognition operations by capturing crucial details pertaining to texture, shape, and structure of objects, thereby facilitating the model's ability to differentiate among various object categories during semantic object recognition operations.

Illustrated processing block 96 provides for performing radiance field view synthesis operations based on semantic object recognition operations. For example, radiance field view synthesis operations are performed based on semantic object recognition operations via the aggregator encoder.

For example, semantic object recognition operations endows radiance field view synthesis operations with semantic knowledge. As the semantic label (e.g., object category) embodies an abstract understanding and generalization of the object, combining the radiance field view synthesis operation task provides guidance to radiance field view synthesis operations learning, consequently enhancing model efficiency.

As illustrated, operations 102-104 may generally be incorporated into block 74 (FIG. 7), already discussed (e.g., the operation to decode, via a rendering decoder, the latent features into one or more novel target views different from views of the multi-view visual data).

Illustrated processing block 102 provides for obtaining a rendered color of a given camera ray as a point-wise color. For example, a rendered color of a given camera ray is obtained as a point-wise color via the rendering decoder.

Illustrated processing block 104 provides for map, via the rendering decoder, one or more token features to the pointwise color. For example, one or more token features is mapped to the pointwise color via the rendering decoder.

As used herein, “token features” is a general term referring to the representations or embeddings used in the Transformer architecture, associated with individual components. These components can include region features, pixel-wise features, or other elements in the input sequence.

As illustrated, operation 112 may generally be incorporated into block 76 (FIG. 7), already discussed (e.g., the operation to decode, via a label decoder, the latent features into an object label). Illustrated processing block 112 provides non-linearly mapping the latent features into a plurality of object categories. For example, the latent features are non-linearly mapped into a plurality of object categories via the label decoder.

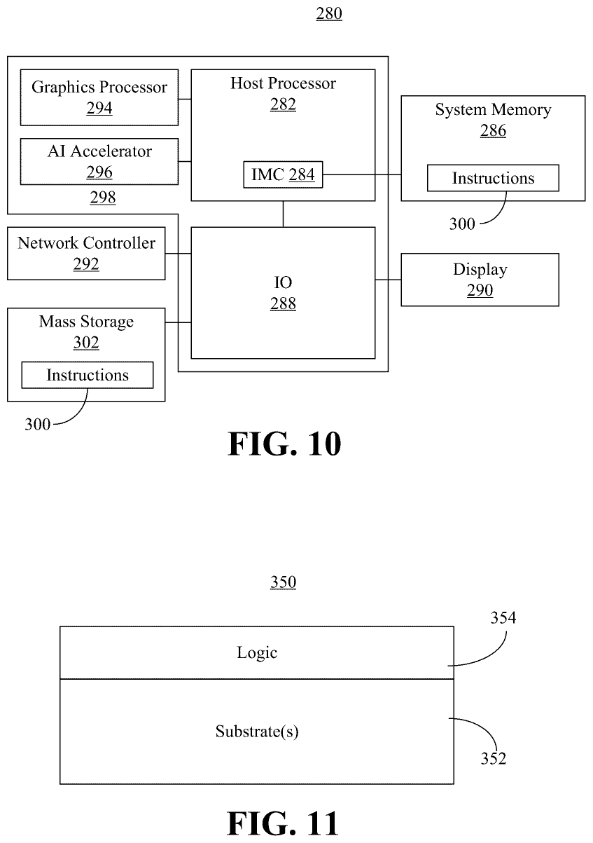

Turning now to FIG. 10, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 into a system on chip (SoC) 298.

In an embodiment, the host processor 282 and/or the AI accelerator 296 executes a set of program instructions 300 retrieved from the mass storage 302 and/or the system memory 286 to perform one or more aspects of the method 70 (FIG. 7), the method 80 (FIG. 8), and/or the method 90 (FIG. 9), already discussed. Thus, execution of the illustrated instructions 300 by the host processor 282 and/or the AI accelerator 296 causes the host processor 282 and/or the AI accelerator 296 to encode multi-view visual data into latent features via the aggregator encoder, decode the latent features into one or more novel target views different from views of the multi-view visual data via a rendering decoder, and decode the latent features into an object label via a label decoder.

The instructions 300 may also be implemented in a distributed architecture (e.g., distributed in both location and over time). For example, the compacted encoding of multi-view visual data into latent features may occur on a separate first processor (not shown) at an earlier time than the execution of the transformer-based neural network decoding on the SoC 298 of the computing system 280 (e.g., a different separate remote second processor at a later time, independent of the earlier processing time). Furthermore, the results of a decoding operation may be stored on a different separate remote third processor (not shown), to be displayed to a human user at a later time, independent of earlier processing times. Thus, the computing system 280 may be understood as illustrating one of a plurality of devices, rather than a single device.

Accordingly, the various processing stages may be initiated based on network messages between distributed processors, using suitable networking protocols, as known to those skilled in the art. For example, the TCP/IP (Transmission Control Protocol/Internet Protocol) suite of protocols, among others. The storage and retrieval of pre-processing, intermediate, and final results may be stored in databases using SQL (Structured Query Language) or No-SQL programming interfaces, among others. The storage elements may be physically located at different places than the processing elements.

The computing system 280 is therefore considered performance-enhanced at least to the extent that by integrating the tasks of 3D object recognition and RF-based novel view synthesis, the semantic-guided transformer for object recognition and radiance-field-based novel view synthesis (2R-TRM) provides mutual benefits to both domains. The integration of these two tasks leads to mutual benefit. On the one hand, RF-based novel view synthesis yields superior 3D object representations, capturing crucial details pertaining to texture, shape, and structure of objects, thereby facilitating the model's ability to differentiate among various object categories. On the other hand, 3D object recognition endows RF-based novel view synthesis with semantic knowledge. As the semantic label embodies an abstract understanding and generalization of the object, combining the recognition task provides guidance to RF-based novel view synthesis learning, consequently enhancing model efficiency.

FIG. 11 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 70 (FIG. 7), the method 80 (FIG. 8), and/or the method (FIG. 9), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

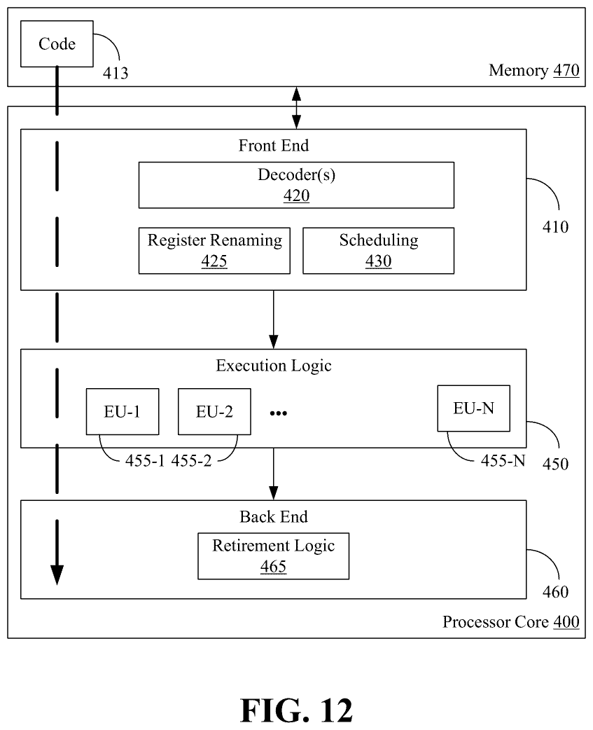

FIG. 12 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 12, a processing element may alternatively include more than one of the processor core 400 illustrated in FIG. 12. The processor core 400 may be a single-threaded core or, for at least one embodiment, the processor core 400 may be multithreaded in that it may include more than one hardware thread context (or “logical processor”) per core.

FIG. 12 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 70 (FIG. 7), the method 80 (FIG. 8), and/or the method 90 (FIG. 9), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 12, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

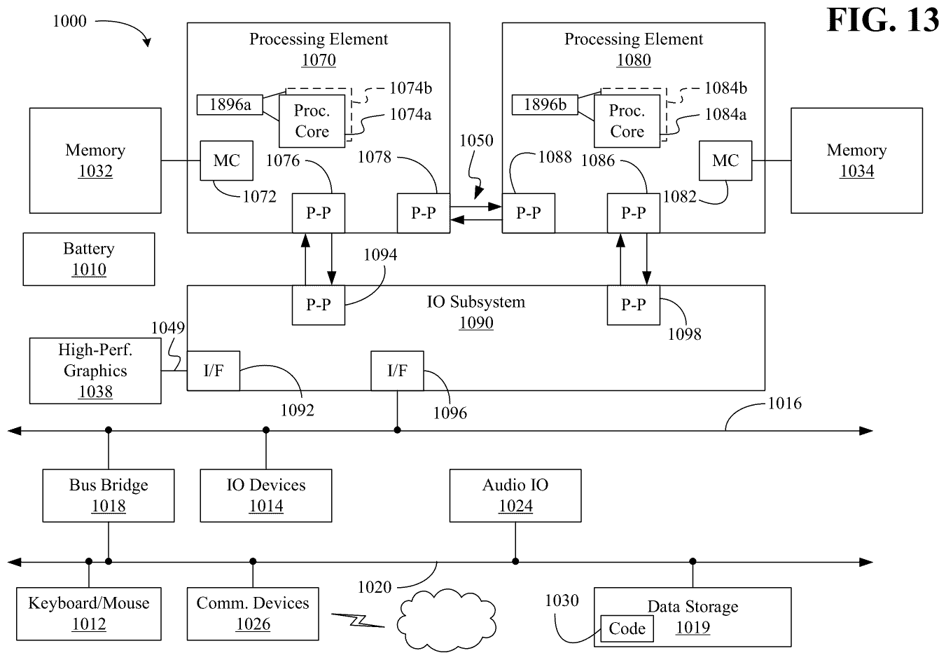

Referring now to FIG. 13, shown is a block diagram of a computing system 1000 embodiment in accordance with an embodiment. The computing system 1000 may be understood as illustrating one of a plurality of computer networks, rather than a single computer network. Shown in FIG. 13 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 13 may be implemented as a multi-drop bus rather than point-to-point interconnect.

As shown in FIG. 13, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 12.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 13, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 13, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 13, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 70 (FIG. 7), the method 80 (FIG. 8), and/or the method 90 (FIG. 9), already discussed. Further, an audio I/O 1024 may be coupled to second bus 1020 and a battery 1010 may supply power to the computing system 1000.

Note that other embodiments are contemplated. For example, instead of the point-to-point architecture of FIG. 13, a system may implement a multi-drop bus or another such communication topology. Also, the elements of FIG. 13 may alternatively be partitioned using more or fewer integrated chips than shown in FIG. 13.

### ADDITIONAL NOTES AND EXAMPLES

Example 1 includes a computing system comprising a network controller, a processor coupled to the network controller, and a memory coupled to the processor, the memory including a set of instructions, which when executed by the processor, cause the processor to encode, via an aggregator encoder, multi-view visual data into latent features, decode, via a rendering decoder, the latent features into one or more novel target views different from views of the multi-view visual data, and decode, via a label decoder, the latent features into an object label.

Example 2 includes the computing system of Example 1, wherein the operation to decode the latent features via the rendering decoder and to decode the latent features via the label decoder occur at least partially at the same time.

Example 3 includes the computing system of any one of Examples 1 to 2, wherein the instructions, when executed, further cause the processor to adjust, via a semantic understanding module, a distance between the latent features and the semantic features, and wherein the operation to encode, via the aggregator encoder, the multi-view visual data into latent features is based on the adjusted distance between the latent features and the semantic features.

Example 4 includes the computing system of any one of Examples 1 to 3, wherein the operation to encode, via the aggregator encoder, the multi-view visual data into the latent features further comprises operations to perform, via the aggregator encoder, semantic object recognition operations based on radiance field view synthesis operations, and perform, via the aggregator encoder, radiance field view synthesis operations based on semantic object recognition operations.

Example 5 includes the computing system of any one of Examples 1 to 4, wherein the instructions, when executed, further cause the processor to aggregate, via the aggregator encoder, the multi-view visual data into a coordinate-aligned feature field, wherein multi-view visual data comprises a plurality of red-green-blue images and a plurality of corresponding camera projection matrices, and wherein multi-view visual data comprises views of a plurality of different objects received together by the aggregator encoder.

Example 6 includes the computing system of any one of Examples 1 to 5, wherein the operation to decode, via the rendering decoder, the latent features into one or more novel target views further comprises operations to obtain, via the rendering decoder, a rendered color of a given camera ray as a point-wise color, and map, via the rendering decoder, one or more token features to the pointwise color, wherein the operation to decode, via the label decoder, the latent features into the object label comprises operations to non-linearly map the latent features into a plurality of object categories.

Example 7 includes the computing system of any one of Examples 1 to 6, wherein the latent features are learned through the joint task of integrating 3D object recognition and radiance field view synthesis to incorporate semantic information from 3D object recognition to aid radiance field view synthesis rendering and incorporate radiance field information from radiance field view synthesis rendering of a 3D scene to enhance the 3D object recognition.

Example 8 includes at least one computer readable storage medium comprising a set of instructions, which when executed by a computing system, cause the computing system to encode, via an aggregator encoder, multi-view visual data into latent features, decode, via a rendering decoder, the latent features into one or more novel target views different from views of the multi-view visual data, and decode, via a label decoder, the latent features into an object label.

Example 9 includes the at least one computer readable storage medium of Example 8, wherein the operation to decode the latent features via the rendering decoder and to decode the latent features via the label decoder occur at least partially at the same time.

Example 10 includes the at least one computer readable storage medium of any one of Examples 8 to 9, wherein the instructions, when executed, further cause the computing system to adjust, via a semantic understanding module, a distance between the latent features and semantic features, and wherein the operation to encode, via the aggregator encoder, the multi-view visual data into latent features is based on the adjusted distance between the latent features and the semantic features.

Example 11 includes the at least one computer readable storage medium of any one of Examples 8 to 10, wherein the operation to encode, via the aggregator encoder, the multi-view visual data into the latent features further comprises operations to perform, via the aggregator encoder, semantic object recognition operations based on radiance field view synthesis operations, and perform, via the aggregator encoder, radiance field view synthesis operations based on semantic object recognition operations.

Example 12 includes the at least one computer readable storage medium of any one of Examples 8 to 11, wherein the instructions, when executed, further cause the computing system to aggregate, via the aggregator encoder, the multi-view visual data into a coordinate-aligned feature field, wherein multi-view visual data comprises a plurality of red-green-blue images and a plurality of corresponding camera projection matrices, and wherein multi-view visual data comprises views of a plurality of different objects received together by the aggregator encoder.

Example 13 includes the at least one computer readable storage medium of any one of Examples 8 to 12, wherein the operation to decode, via the rendering decoder, the latent features into one or more novel target views further comprises operations to obtain, via the rendering decoder, a rendered color of a given camera ray as a point-wise color, and map, via the rendering decoder, one or more token features to the pointwise color.

Example 14 includes the at least one computer readable storage medium of any one of Examples 8 to 14, wherein the operation to decode, via the label decoder, the latent features into the object label comprises operations to non-linearly map the latent features into a plurality of object categories.

Example 15 includes a method comprising encoding, via an aggregator encoder, multi-view visual data into latent features, decoding, via a rendering decoder, the latent features into one or more novel target views different from views of the multi-view visual data, and decoding, via a label decoder, the latent features into an object label.

Example 16 includes the method of Example 15, wherein the operation to decode the latent features via the rendering decoder and to decode the latent features via the label decoder occur at least partially at the same time.

Example 17 includes the method of any one of Examples 15 to 16, further comprising adjusting, via a semantic understanding module, a distance between the latent features and semantic features, and wherein the operation to encode, via the aggregator encoder, the multi-view visual data into latent features is based on the adjusted distance between the latent features and the semantic features.

Example 18 includes the method of any one of Examples 15 to 17, further comprising aggregating, via the aggregator encoder, the multi-view visual data into a coordinate-aligned feature field, wherein multi-view visual data comprises a plurality of red-green-blue images and a plurality of corresponding camera projection matrices, and wherein multi-view visual data comprises views of a plurality of different objects received together by the aggregator encoder.

Example 19 includes the method of any one of Examples 15 to 18, wherein the operation to decode, via the rendering decoder, the latent features into one or more novel target views further comprises operations to obtain, via the rendering decoder, a rendered color of a given camera ray as a point-wise color, and map, via the rendering decoder, one or more token features to the pointwise color.

Example 20 includes the method of any one of Examples 15 to 119, wherein the operation to decode, via the label decoder, the latent features into the object label comprises operations to non-linearly map the latent features into a plurality of object categories.

Example 21 includes the method of any one of Examples 15 to 20, wherein the operation to encode, via the aggregator encoder, the multi-view visual data into the latent features further comprises operations to perform, via the aggregator encoder, semantic object recognition operations based on radiance field view synthesis operations, and perform, via the aggregator encoder, radiance field view synthesis operations based on semantic object recognition operations.

Example 22 includes an apparatus comprising means for performing the method of any one of Examples 15 to 21.

Technology described herein therefore enables AI (e.g., machine learning) tools to be created for integrating the tasks of 3D object recognition and RF-based novel view synthesis to provides mutual benefits to both domains.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of instructions, which when executed by the processor, cause the processor to:
encode, via an aggregator encoder, multi-view visual data into latent features;
decode, via a rendering decoder, the latent features into one or more novel target views different from views of the multi-view visual data; and
decode, via a label decoder, the latent features into an object label.

2. The computing system of claim 1, wherein the operation to decode the latent features via the rendering decoder and to decode the latent features via the label decoder occur at least partially at the same time.

3. The computing system of claim 1, wherein the instructions, when executed, further cause the processor to:
adjust, via a semantic understanding module, a distance between the latent features and semantic features; and
wherein the operation to encode, via the aggregator encoder, the multi-view visual data into latent features is based on the adjusted distance between the latent features and the semantic features.

4. The computing system of claim 1, wherein the operation to encode, via the aggregator encoder, the multi-view visual data into the latent features further comprises operations to:
perform, via the aggregator encoder, semantic object recognition operations based on radiance field view synthesis operations; and
perform, via the aggregator encoder, radiance field view synthesis operations based on semantic object recognition operations.

5. The computing system of claim 1, wherein the instructions, when executed, further cause the processor to:
aggregate, via the aggregator encoder, the multi-view visual data into a coordinate-aligned feature field;
wherein multi-view visual data comprises a plurality of red-green-blue images and a plurality of corresponding camera projection matrices; and
wherein multi-view visual data comprises views of a plurality of different objects received together by the aggregator encoder.

6. The computing system of claim 1, wherein the operation to decode, via the rendering decoder, the latent features into one or more novel target views further comprises operations to:
obtain, via the rendering decoder, a rendered color of a given camera ray as a point-wise color; and
map, via the rendering decoder, one or more token features to the pointwise color,
wherein the operation to decode, via the label decoder, the latent features into the object label comprises operations to non-linearly map the latent features into a plurality of object categories.

7. The computing system of claim 1, wherein the latent features are learned through the joint task of integrating 3D semantic object recognition and radiance field view synthesis to incorporate semantic information from 3D semantic object recognition to aid radiance field view synthesis rendering and incorporate radiance field information from radiance field view synthesis rendering of a 3D scene to enhance the 3D semantic object recognition.

8. At least one computer readable storage medium comprising a set of instructions, which when executed by a computing system, cause the computing system to:
encode, via an aggregator encoder, multi-view visual data into latent features;
decode, via a rendering decoder, the latent features into one or more novel target views different from views of the multi-view visual data; and
decode, via a label decoder, the latent features into an object label.

9. The at least one computer readable storage medium of claim 8, wherein the operation to decode the latent features via the rendering decoder and to decode the latent features via the label decoder occur at least partially at the same time.

10. The at least one computer readable storage medium of claim 8, wherein the instructions, when executed, further cause the computing system to:
adjust, via a semantic understanding module, a distance between the latent features and semantic features; and
wherein the operation to encode, via the aggregator encoder, the multi-view visual data into latent features is based on the adjusted distance between the latent features and the semantic features.

11. The at least one computer readable storage medium of claim 8, wherein the operation to encode, via the aggregator encoder, the multi-view visual data into the latent features further comprises operations to:
perform, via the aggregator encoder, semantic object recognition operations based on radiance field view synthesis operations; and
perform, via the aggregator encoder, radiance field view synthesis operations based on semantic object recognition operations.

12. The at least one computer readable storage medium of claim 8, wherein the instructions, when executed, further cause the computing system to:
aggregate, via the aggregator encoder, the multi-view visual data into a coordinate-aligned feature field;
wherein multi-view visual data comprises a plurality of red-green-blue images and a plurality of corresponding camera projection matrices; and
wherein multi-view visual data comprises views of a plurality of different objects received together by the aggregator encoder.

13. The at least one computer readable storage medium of claim 8, wherein the operation to decode, via the rendering decoder, the latent features into one or more novel target views further comprises operations to:
obtain, via the rendering decoder, a rendered color of a given camera ray as a point-wise color; and
map, via the rendering decoder, one or more token features to the pointwise color.

14. The at least one computer readable storage medium of claim 8, wherein the operation to decode, via the label decoder, the latent features into the object label comprises operations to non-linearly map the latent features into a plurality of object categories.

15. A method comprising:
encoding, via an aggregator encoder, multi-view visual data into latent features;
decoding, via a rendering decoder, the latent features into one or more novel target views different from views of the multi-view visual data; and
decoding, via a label decoder, the latent features into an object label.

16. The method of claim 15, wherein the operation to decode the latent features via the rendering decoder and to decode the latent features via the label decoder occur at least partially at the same time.

17. The method of claim 15, further comprising:
encoding, via the aggregator encoder, the multi-view visual data into latent features;
adjusting, via a semantic understanding module, a distance between the latent features and semantic features; and
wherein the operation to encode, via the aggregator encoder, the multi-view visual data into latent features is based on the adjusted distance between the latent features and the semantic features.

18. The method of claim 15, further comprising:
aggregating, via the aggregator encoder, the multi-view visual data into a coordinate-aligned feature field;
wherein multi-view visual data comprises a plurality of red-green-blue images and a plurality of corresponding camera projection matrices; and
wherein multi-view visual data comprises views of a plurality of different objects received together by the aggregator encoder.

19. The method of claim 15, wherein the operation to decode, via the rendering decoder, the latent features into one or more novel target views further comprises operations to:
obtain, via the rendering decoder, a rendered color of a given camera ray as a point-wise color; and
map, via the rendering decoder, one or more token features to the pointwise color.

20. The method of claim 15, wherein the operation to decode, via the label decoder, the latent features into the object label comprises operations to non-linearly map the latent features into a plurality of object categories.
